(19) United States
(12) Patent Application Publication
(10) Pub. No.: US 2011/0240631 A1
(43) Pub. Date: Oct. 6, 2011

(54) ELECTRICAL HEATING UNIT, PARTICULARLY FOR CARS

(76) Inventors: Michael Luppold, Dettenheim-Lie (DE); Alexander Dauth, Maulbronn (DE); Hans-Peter Etzkorn, Bruchsal (DE); Rolf Merte, Wiesloch (DE)

(21) Appl. No.: 12/594,236

(22) PCT Filed: Mar. 26, 2008
(86) PCT No.: PCT/EP2008/002357

§ 371 Date: Dec. 15, 2009

(30) Foreign Application Priority Data
Apr. 4, 2007 (DE) 10 2007 016 780.8

(51) Int. Cl. H05B 3/02

(52) U.S. Cl. 219/530

(57) ABSTRACT

The invention relates to a heater comprising at least one electric heating element and at least one heat-dissipating panel that has holes through which a fluid to be heated can flow, The heat-dissipating panel is heat conductively connected at the at least one heating element and is provided with a front side facing the heating element and a rear side. In an area lying across from the heating element, the heat-dissipating panel has a cross-section that is open towards the heating element.

The invention concerns to an electrical heating unit. DE 101 02 671 A1 discloses a heating unit, which has several heating rods parallel to one another, filled with PTC heating elements. Several lamellar plates are clampingly slid on to the heating rods: The plates act as heat exchangers and also hold the heating rods together. A connecting line comes out from one end of the heating rods. This line is connected to the PTC heating elements. The housing of the corresponding heating rod acts as an electric ground connection to the PTC elements.

The known heating unit has several disadvantages: The process of manufacture of the heating unit involves many individual steps. The heating rods are equipped with the PTC elements and then pressed in order to create a good heat-conducting connection between the PTC elements and the housing of the heating rods. The lamellae are punched out from sheet metal and slid on to the heating rods individually. The mechanical and heat-conducting connection between the lamellae and the heating rods is established by clamping. As a result, the heat flow from the heating rods to the lamellae is restricted due to the small area of contact points between the lamellae and the housing of the heating rods. The medium, to which the heat generated by the PTC heating elements should be transferred, is—in the case disclosed in DE 101 02 671 A1—air, which heats up the inner space of a car. The air flows through the heating unit transverse to the heating rods and tangentially to the lamellae. In the heating unit known, the process of heat transfer is not particularly effective. For transferring the desired thermal output in spite of this, several lamellae are arranged in close succession on the heating rods; as a result, the manufacturing is costly and time-consuming.

The EP 1 370 117 A2 discloses an electrical heating unit with PTC heating elements for heating the inner space of cars, whereby the heat exchanger is not built using a number of individual lamellae, but using extruded profile sections that are formed by an extruded profile, which is divided crossways and has several chambers, whereby the chambers are separated from one another by thin walls. Several identical extruded profile sections are arranged next to one another perpendicular to the direction of extrusion. The PTC heating elements are arranged between every two extruded profile sections next to one another. By bracing them into a common frame to form a module, the heating elements are fixed. The air, which is supposed to transfer the heat generated by the PTC heating elements, flows through the extruded profile sections in the direction of extrusion, tangential to the surfaces of the several chambers formed in the extruded profile sections. Although the assembly work for the heat exchanger of the heating unit known from EP 1 370 117 A2 is reduced compared to the heating unit known from DE 101 02 671 A1, the efficiency of the heat transfer is not higher than in the case of DE 101 02 671 A1. Moreover, in the heating unit defined in EP 1 370 117 A2, the PTC heating elements, their supply lines and electrical contact points are exposed to the influence of air, on which the heat is to be transferred, thereby causing an increased contact resistance and corrosion.

This invention aims at reducing the manufacturing cost and effort for an electrical heating unit of the type mentioned in the beginning and improving the heat transfer. This can be achieved with a heating unit having the features mentioned in the patent claim 1. Advantageous modifications of the invention are subject matter of dependent claims.

A heating unit according to the present invention has a heat dissipating panel as heat exchanger, which has holes through which the fluid to be heated flows. When the fluid flows through the holes of the heat dissipating panel, the heat generated by a heating element is transmitted to the fluid to be heated.

The heat dissipating panel of a heating unit according to this invention has cross-section open towards the heating element and can be an inexpensive perforated plate, for example. In contrast to expensive extruded sections, which have a cross-section enclosing the heating element, the heat dissipating panel of a heating unit according to this invention can be manufactured in a cost-effective manner. While punching out the holes, indentions can be made in the heat dissipating panel, in which the heating element(s) can be arranged. However, it is not necessary to make such indentions in an open cross-section, because even a flat heat dissipating panel faces a heating element positioned on it with an open cross-section, i.e. with a flat cross-section.

Preferably, the heating element of a heating unit according to this invention is a PTC heating element, which is electrically contacted on opposite contact surfaces, for example the upper and lower side of a cuboid. The heat dissipating panel is turned towards a contact surface and can enclose one or more side faces of the heating element with its open cross-section. However, the second contact surface is turned away from the heat dissipating panel and not enclosed by it. Thus, the heat dissipating panel of a heating unit according to the invention is only turned towards one of the two contact surfaces of the heating element.

An advantage of the heating unit defined by this invention is the low manufacturing cost of its component parts; besides, the unit is very easy to assemble. Since the heat dissipating panel has a flat or an open cross-section towards the heating element, the heating element can be easily positioned on the heat dissipating panel, particularly in the indentions embossed in it and even be directly soldered on the panel. Thus, the expensive procedure of integrating heating elements in a housing is avoided in the heating unit defined by this invention.

Preferably, the at least one heating element is installed between two heat dissipating panels. Thereby, the flow path, on which the heat generated by the heating element(s) is transmitted to the fluid to be heated, will increase. Thus, the use of two heat dissipating panels leads to a better dissipation of heat to the fluid that flows through the holes of both heat dissipating panels.

Further details and advantages of the heating unit of by this invention are explained with the help of embodiments with reference to the drawings attached herewith. In the drawings, identical parts and parts corresponding to one another are marked with the same reference numbers. In the figures:

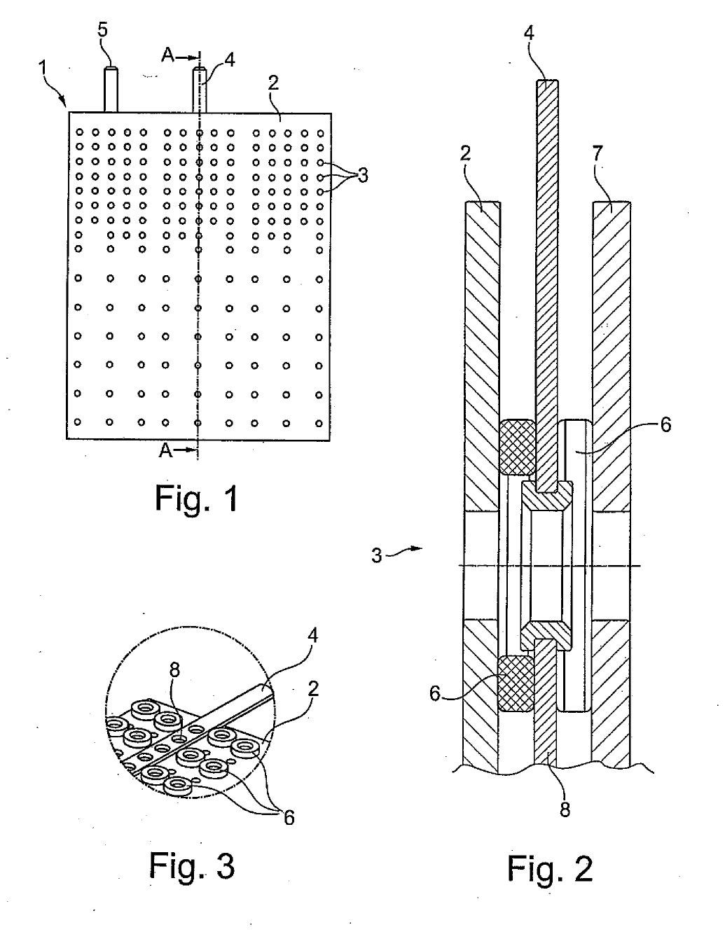

FIG. 1 shows an embodiment of a heating unit of this invention;

FIG. 2 shows a sectional view of FIG. 1 in the area of a hole;

FIG. 3 shows a detail of FIG. 1, whereby one of the two heat dissipating panels, between which the heating elements are arranged, is removed;

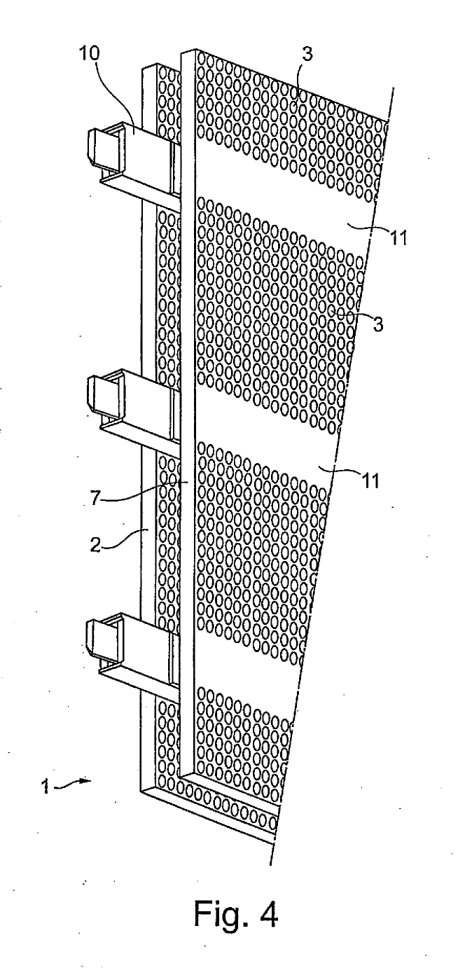

FIG. 4 shows another embodiment of a heating unit of this invention;

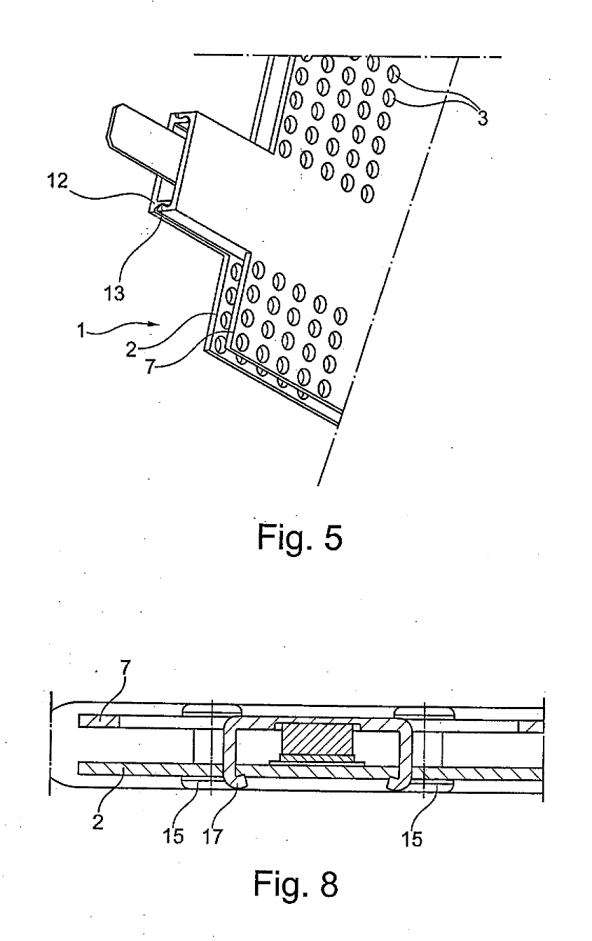

FIG. 5 shows a detail of another embodiment of a heating unit of this invention;

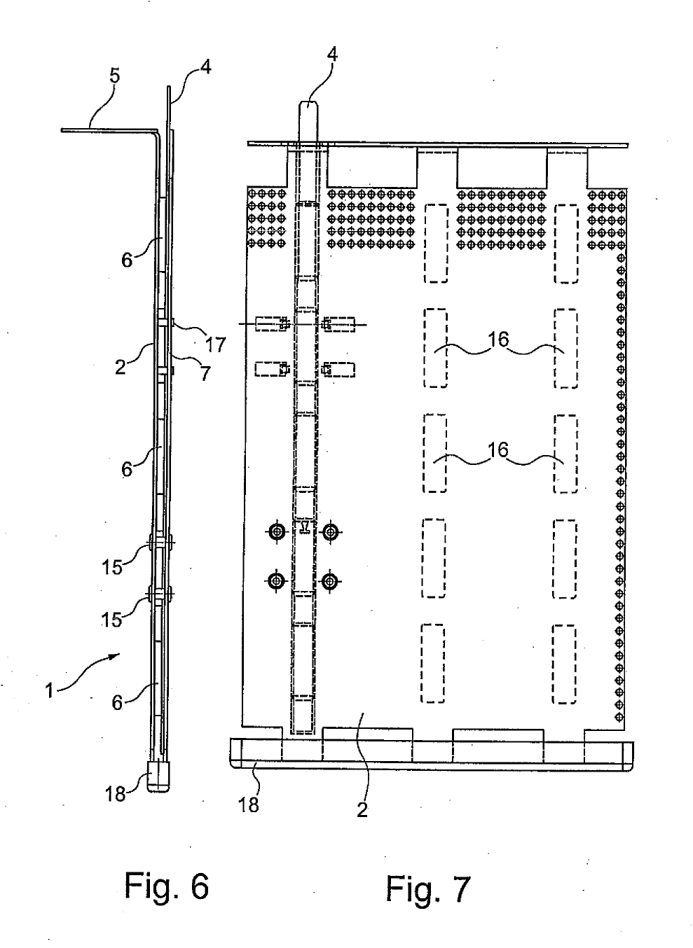

FIG. 6 shows a side view of another embodiment of a heating unit of this invention;

FIG. 7 shows a sectional view of FIG. 6;

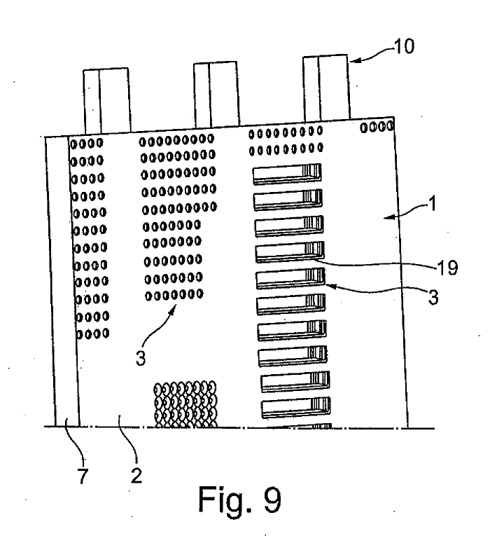

FIG. 8 shows another sectional view of FIG. 6; and

FIG. 9 shows another embodiment of a heating unit of by this invention.

FIG. 1 shows an embodiment of a heating unit 1 as defined by the invention, which is particularly suitable as a heating unit for heating the interior of a car. The heating unit 1 has a heat dissipating panel 2 in the form of a perforated plate, which has a number of holes 3, through which the air current to be heated flows. The perforated plate 2 has more than 20, particularly more than 50, even more than 100 holes 3 and is shown in FIG. 1 in a top view.

The heating unit has one potential connection 4 and one ground connection 5 for conducting a heating current through the PTC heating elements 6 of the heating unit 1 as shown in FIGS. 2 and 3.

FIG. 2 shows a cross-sectional view of FIG. 1 along the intersection line AA in the area of a hole 3. The structure of a heating unit 1 in the area of the remaining holes 3 along the intersection line AA corresponds to FIG. 2. The heating unit 1 has two perforated plates 2, 7, between which the heating elements 6 are arranged. The holes 3 of the opposite perforated plates 2, 7 are arranged in a well-aligned manner. In the embodiment shown here, the electrical heating elements 6 have ring-shaped PTC heating elements. The heating elements 6 have an opening, which is aligned with a hole 3 of the perforated plate 2, 7.

The two perforated plates 2, 7 are electrically connected to the terminal 5 shown in FIG. 1; usually, this is a ground connection. A contact blade 8 is arranged between the two perforated plates 2, 7, which is also connected to the terminal 4 shown in FIG. 1; usually, this is a potential connection. On both the sides, the contact stud 8 is connected to heating elements 3; hence, the contact blade 8 is arranged between the heating elements 3. In the embodiment shown, the contact blade 8 also has holes, which align with the holes 3 in the perforated plates 2, 7, so that the air current to be heated flows properly through the heating unit 1.

FIG. 3 shows one of the perforated plates 2, 7 of the embodiment with the heating elements 6 and the contact blade 8 installed on it. Using a large number of smaller heating elements 6 as shown in the embodiment facilitates a uniform dissipation of heat over a large area.

The heat dissipating panels 2, 7 are preferably made of aluminium or aluminium alloy or a good heat-conducting metal, such as copper or a copper alloy. For manufacturing the heating unit 1, a solder paste is applied on the front side of a heat dissipating panel 2, 7, e.g. by screen printing. Then, the heating elements 6 are positioned on the heat dissipating panel. After this, a contact blade 8 with solder paste applied on both sides is mounted on the heating elements 6. In the next step, a second layer of heating elements 6 is mounted on the contact blade 8. Then, the second heat dissipating panel 7 (on which solder paste is applied as well) is placed. The interconnection thus formed is soldered by heat treatment, for example in a reflow process. In this way, a good electrical and heat-conducting connection is achieved between the heat dissipating panels 2, 7, the heating elements 6 and the contact blade 8.

FIG. 4 shows another embodiment of a heating unit 1. In this example shown in FIG. 4, the heating elements are arranged in tubular housings 10, which are arranged between the perforated plates 2, 7. The perforated plates 2, 7 are soldered with the heating rods 10 so that the best possible thermal contact is achieved. In an area 11 adjacent to the heating rods 10, the perforated plates 2, 7 do not have any holes 3, so that heat can be dissipated by the heating rods 10 over an area as large as possible.

FIG. 5 shows another embodiment of a heating unit 1. In contrast to the embodiment shown in FIG. 4, no separate heating rods are required here. The heat dissipating panels 2, 7 are locked by means of projections, which form the side walls of a chamber, in which the heating elements are arranged. In the embodiment shown, both heat dissipating panels 2, 7 have two projections each 12 or 13. However, it is also possible to provide projections 12, 13, which form detent rails, on only one of the two heat dissipating panels 2; these get engaged in slots of the other heat dissipating panel 2, 7. It is also possible to provide only one projection 12, 13 on each heat dissipating panel 2, 7; this engages in a slot of the other perforated plate 2, 7 and as a result, an oblong chamber is created for one or more heating elements by connecting the two heat dissipating panels 2, 7.

A suitable heat dissipating panel 2, 7 with strip-shaped projections can be formed, for example by extrusion and by subsequently punching out the holes 3. Other possibilities are for example deep-drawing, embossing or milling of a metal plate or sheet metal.

In the embodiment shown in FIG. 5, it is important that both the heat dissipating panels 2, 7 have an open cross-section in the area opposite to the heating element, so that the heating elements can be easily positioned there and a chamber enclosing the heating elements is formed only by joining the two heat dissipating panels 2, 7.

FIG. 6 shows another embodiment of a heating unit 1 in a side view. In contrast to the embodiment explained with FIGS. 1 to 3, this embodiment shows that both heat dissipating panels 2, 7 in the form of perforated plates, between which the heating elements 6 are located, are interlocked, i.e. with rivets 15. The perforated plates 2, 7 are inserted in a base 18, which also connects the perforated plates and holds them together.

FIG. 7 shows a sectional view of FIG. 6. The perforated sheet 2, 7 of this embodiment has punched dents 16, which make it easy to position the PTC heating elements 6. In this embodiment, the punched dents 16 and the PTC heating elements 6 are rectangular, but they can have any other shape. After positioning the PTC heating elements 6 in the punched dents 16, the second perforated plate 7 is placed on the first perforated plate 2 and the perforated plates 2, 7 are interlocked by means rivets 15 and/or clamps 17. FIG. 8 shows a detailed view of FIGS. 6 and 7 in which rivets 15 and a clamp 17 can be seen clearly.

FIG. 9 shows another embodiment of a heating unit 1. This embodiment largely corresponds to the embodiment described with the help of FIG. 4. This embodiment differs, because some holes of the perforated plate 3 are designed as oblong holes, which are joined to its edge with a metallic surface 19 arranged transversely to the perforated plate level. The metallic surface 19 was formed by bending it out from the perforated plate 2, 7. The metallic surface 19 increases the area, over which the heating device 1 transmits heat to the air current flowing through the holes 3.

### REFERENCE NUMBERS

1 Heating unit

2 Heat dissipating panel

3 Holes

4 Potential connection

5 Ground connection

6 Heating element

7 Heat dissipating panel

8 Contact blade

10 Heating rod

11 Area of the heat dissipating panel without holes

12 Catch projection

13 Catch projection

15 Rivet

16 indention

17 Clamp

18 Pedestal

19 Metallic surface

1. Heating unit comprising at least one electrical heating element (6) and at least one heat dissipating panel (2, 7), which has holes (3) through which a fluid to be heated can pass and which is connected heat conductively to the at least one heating element (6), whereby the heat dissipating panel (2, 7) has a front side that faces the heating element (6) and a back side, and whereby the heat dissipating panel (2, 7) has an open cross-section towards the heating element (6) in an area (10) opposite to the heating element (6).

2. Heating unit according to claim 1, characterized in that, the heat dissipating panel (2, 7) is a perforated metal sheet.

3. Heating unit according to claim 1, characterized in that, the heat dissipating panel (2, 7) is a perforated extruded section.

4. Heating unit according to any one of the preceding claims, characterized in that, the heat dissipating panel (2, 7) has an even cross-section in the area (10) that lies opposite to the heating element (6).

5. Heating unit according to any one of the preceding claims, characterized in that, the at least one heating element (6) is soldered with the heat dissipating panel (2, 7).

6. Heating unit according to any one of the preceding claims, characterized in that, at least one heating element (6) is arranged between two heat dissipating panels (2, 7).

7. Heating unit according to claim 6, characterized in that, both the heat dissipating panels (2, 7) are joined with positive locking.

8. Heating unit according to claim 7, characterized in that, the heat dissipating panels (2, 7) are snapped or riveted together.

9. Heating unit according to claim 8, characterized in that, the heat dissipating panels (2, 7) are locked by means of projections (12, 13), which form side walls of a chamber, in which at least one heating element (6) is arranged.

10. Heating unit according to any of claims 6 to 9, characterized in that the holes (3) of the opposite heat dissipating panels (2, 7) are arranged in a well-aligned manner.

11. Heating unit according to any one of the preceding claims, characterized in that, at least one heating element (6) has an opening, which is aligned with a hole (3) of the heat dissipating panel (2, 7).

12. Heating unit according to any one of the preceding claims, characterized in that at least one heating element (6) is arranged in an indention (16) of the heat dissipating panel (2, 7).

13. Heating unit according to any one of the preceding claims, characterized in that at least one heat dissipating panel (2, 7) is joined with a housing (10), in which at least one heating element (6) is arranged.

14. Heating unit according to arty one of the preceding claims, characterized in that at least some holes (3) of at least one heat dissipating panel (2, 7) are joined at their edge with a metallic surface (19), which is arranged transversely to the level of the heat dissipating panel.

15. Heating unit according to claim 14, characterized in that the metallic surface (19) that is arranged transversely to the level of the heat dissipating panel is formed by bending out from the heat dissipating panel (2, 7).

16. Heating unit according to any one of the preceding claims characterized in that at least one heat dissipating panel (2, 7) has at least 20, preferably at least 50, or particularly at least 100 holes (3) through which the fluid to be heated can pass.
